(19) United States
(12) Patent Application Publication
(10) Pub. No.: US 2026/0088469 A1
(43) Pub. Date: Mar. 26, 2026

(54) RIVETING STRUCTURE FOR CELL POSTS

(71) Applicants: FARASIS ENERGY (GANZHOU) CO., LTD., Ganzhou (CN); FARASIS ENERGY (ZHENJIANG) CO., LTD., Zhenjiang (CN)

(72) Inventors: Weiran JIANG, Ganzhou (CN); Jianwei CHEN, Ganzhou (CN); Fei XIAO, Ganzhou (CN); Wei LIU, Ganzhou (CN); Yiqi HUANG, Ganzhou (CN); Zhigang WANG, Ganzhou (CN); Jun LIU, Ganzhou (CN)

(73) Assignees: FARASIS ENERGY (GANZHOU) CO., LTD., Ganzhou (CN); FARASIS ENERGY (ZHENJIANG) CO., LTD., Zhenjiang (CN)

(21) Appl. No.: 18/963,824

(22) Filed: Nov. 29, 2024

(30) Foreign Application Priority Data
Sep. 24, 2024 (CN) 202411330159.X

(51) Int. Cl. H01M 50/567; H01M 50/184

(52) U.S. Cl. CPC H01M 50/567; H01M 50/184

(57) ABSTRACT

Disclosed is a riveting structure for cell posts. A cell comprises a lower shell, an external terminal and a current collector, the external terminal is arranged on an outer side of the lower shell, and the current collector is arranged on an inner side of the lower shell; and the external terminal has an inner surface facing the lower shell and an outer surface backing on to the lower shell. In the invention, the post is fixed to the inner surface of the external terminal and then penetrates through the first through-hole in the lower shell to be riveted to the current collector. In this way, a weld protrusion generated by welding the post to the outer surface of the external terminal is avoided, and the outer surface of the external terminal is smoother and can be in tighter fit with the busbar, thus improving the current stability.

### BACKGROUND OF THE INVENTION

### 1. Technical Field

The invention relates to the technical field of batteries, in particular to a riveting structure for cell posts.

### 2. Description of Related Art

With the development of the new energy industry, more and more batteries are applied to the automobile or energy storage field. Wherein, posts are important conducting components in batteries.

A square battery typically comprises a shell, an external terminal is arranged on an outer side of the shell, a post is welded to an outer side of the external terminal, and then, the outer side of the external terminal is connected to a busbar.

However, the busbar and the external terminal cannot well fit with each other under the effect of the post on the outer side of the external terminal, and even if a space for the post is reserved on the external terminal, there will be a weld protrusion between the post and the external terminal, and the height and size of the protrusion cannot be controlled, making it impossible to realize tight fit between the busbar and the external terminal and leading to poor current stability.

### BRIEF SUMMARY OF THE INVENTION

In view of the above-mentioned defects in the prior art, the technical issue to be settled by the invention is to provide a riveting structure for cell posts to solve the problem that a busbar and an external terminal cannot be in tight fit due to the presence of a weld protrusion of a post in the prior art.

The technical solution adopted by the invention to settle the above technical issue is as follows: a riveting structure for cell posts, wherein a cell comprises a lower shell, an external terminal and a current collector, the external terminal is arranged on an outer side of the lower shell, and the current collector is arranged on an inner side of the lower shell; the external terminal has an inner surface facing the lower shell and an outer surface backing on to the lower shell, the outer surface of the external terminal is connected to a busbar, a first through-hole is formed in the lower shell, and a post has an end fixedly connected to the inner surface of the external terminal as well as an end penetrating through the first through-hole and riveted to the current collector;
the post comprises a first connecting segment and a second connecting segment, and a first step surface is formed at a joint between the first connecting segment and the second connecting segment; from the second connecting segment to the first connecting segment, a cross-sectional area of the second connecting segment becomes smaller gradually;
a second through-hole is formed in the current collector, and a cross-sectional area of the second through-hole is greater than a maximum cross-sectional area of the second connecting segment and less than a cross-sectional area of the first connecting segment.

Further, the post is fixed to the inner surface of the external terminal by welding or is integrally formed on the inner surface of the external terminal by pressure casting.

Further, the second through-hole is a circular hole, and a cross-section of the first connecting segment and a cross-section of the second connecting segment are both circular.

Further, a plurality of protrusions are arranged on the step surface.

Further, the plurality of protrusions on the step surface are saw-toothed.

Further, two posts are fixedly connected to the inner surface of the external terminal;
two first through-holes are formed in the lower shell;
one current collector is arranged on the inner side of the lower shell, two second through-holes are formed in the current collector, and each of the two posts penetrates through one first through-hole to be fixed to the current collector.

Further, two posts are fixedly connected to the inner surface of the external terminal;
two first through-holes are formed in the lower shell;
two current collectors are arranged on the inner side of the lower shell, one second through-hole is formed in each current collector, and each of the two posts penetrates through one first through-hole to be fixed to the current collector.

Further, a first plastic part is arranged between the external terminal and the lower shell, and a second plastic part is arranged between the lower shell and the current collector.

Further, a sealing ring is arranged at the first through-hole.

Compared with the prior art, the invention has at least the following beneficial effects:

(1) The post is fixed to the inner surface of the external terminal and then penetrates through the first through-hole in the lower shell to be riveted to the current collector. In this way, a weld protrusion generated by welding the post to the outer surface of the external terminal is avoided, and the outer surface of the external terminal is smoother and can be in tighter fit with the busbar, thus improving the current stability.

(2) Before a battery is assembled, the post is fixed to the inner surface of the external terminal to form a whole, and then the external terminal and the post are mounted on the lower shell as a whole, such that the number of parts can be reduced during installation, and the assembly efficiency is improved.

(3) Circular saw-teeth are arranged on the step surface and can be inlaid in the current collector during riveting to prevent the post and the current collector from rotating relatively, thus improving the connection strength of the post and the current collector.

### BRIEF DESCRIPTION OF THE SEVERAL VIEWS OF THE DRAWINGS

FIG. 1 is an exploded view of a cell according to one embodiment;

FIG. 2 is a structural view of an external terminal and a post according to one embodiment;

FIG. 3 is an enlarged view of part A in FIG. 2;

FIG. 4 is a structural view of a current collector according to one embodiment;

### IN THE FIGS.

100, external terminal;
200, lower shell; 210, first through-hole;
300, current collector; 310, second through-hole;
400, post; 410, first connecting segment; 420, second connecting segment; 430, protrusion;
500, first plastic part;
600, second plastic part;
700, sealing ring.

### DETAILED DESCRIPTION OF THE INVENTION

The technical solution of the invention is further described below in conjunction with specific embodiments and accompanying drawings of the invention, but the invention is not limited to the following embodiments.

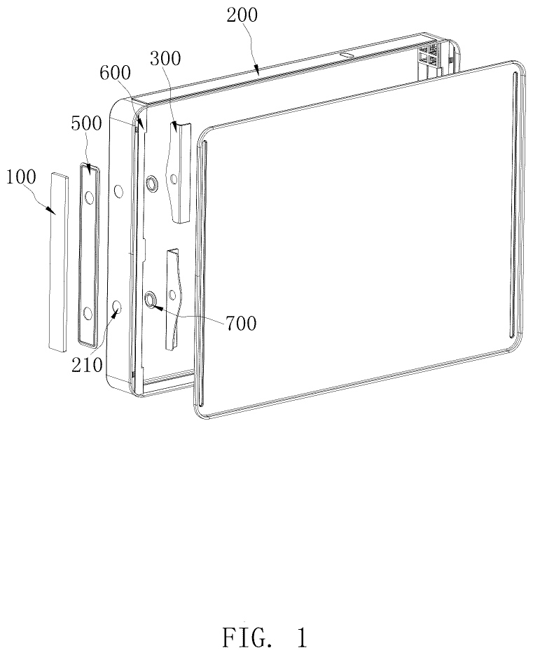

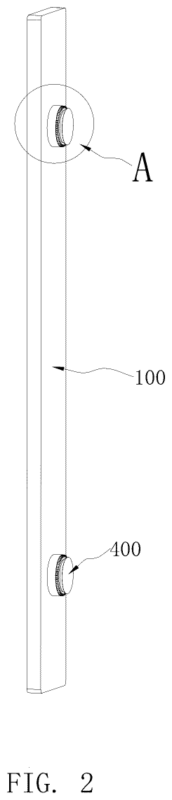

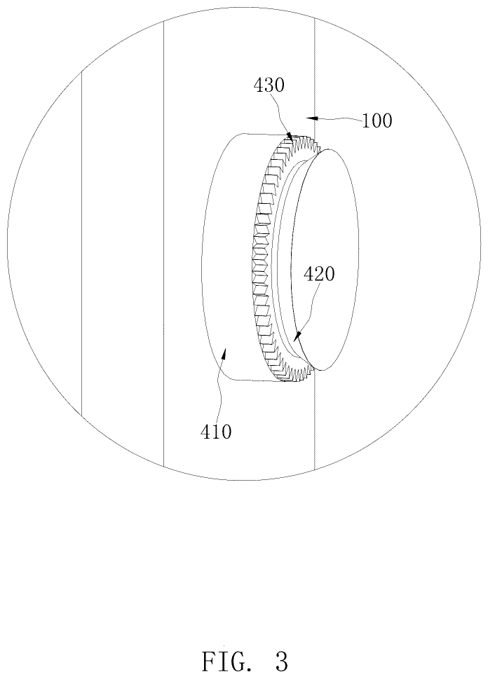

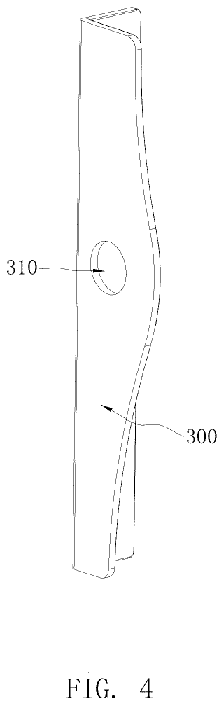

Referring to FIGS. 1-4, the invention discloses a riveting structure for cell posts, wherein a cell comprises a lower shell 200, an external terminal 100 and a current collector 300, the external terminal 100 is arranged on an outer side of the lower shell 200, and the current collector 300 is arranged on an inner side of the lower shell 200; the external terminal 100 has an inner surface facing the lower shell 200 and an outer surface backing on to the lower shell 200, the outer surface of the external terminal 100 is connected to a busbar, a first through-hole 210 is formed in the lower shell 200, one end of a post 400 is fixedly connected to the inner surface of the external terminal 100, and the other end of the post 400 penetrates through the first through-hole 210 and riveted to the current collector 300;
the post 400 comprises a first connecting segment 410 and a second connecting segment 420, and a first step surface is formed at a joint between the first connecting segment 410 and the second connecting segment 420; and from the second connecting segment 420 to the first connecting segment 410, a cross-sectional area of the second connecting segment 420 becomes smaller gradually;
a second through-hole 310 is formed in the current collector 300, and a cross-sectional area of the second through-hole 310 is greater than a maximum cross-sectional area of the second connecting segment 420 and less than a cross-sectional area of the first connecting segment 410.

Specifically, because the cross-sectional area of the second connecting segment 420 becomes smaller gradually towards the first connecting segment 410, a riveting space is formed around the second connecting segment 420 close to the step surface; when the second connecting segment 420 stretches into to the second through-hole 310 and the step surface abuts against the current collector 300, the post 400 and the current collector 300 will be squeezed, and the step surface will squeeze a material of the current collector 300 in the vicinity of the second through-hole 310 until the material is inlaid in the riveting space, such that the post 400 and the current collector 300 are riveted and fixed together.

It should be noted that because the maximum cross-sectional area of the second connecting segment 420 is less than the cross-sectional area of the second through-hole 310, the second connecting segment 420 can stretch into the second through-hole 310; and because the cross-sectional area of the first connecting segment 410 is greater than the cross-sectional area of the second through-hole 310, the step surface can abut against the current collector 300 and squeeze the current collector 300 to rivet together the post 400 and the current collector 300.

Particularly, in the application, the post 400 is fixed to the inner surface of the external terminal 100 and then penetrates through the first through-hole 210 in the lower shell 200 to be riveted to the current collector 300. In this way, a weld protrusion 430 generated by welding the post 400 to the outer surface of the external terminal 100 is avoided, and the outer surface of the external terminal 100 is smoother and can be in tighter fit with the busbar, thus improving the current stability.

It should be noted that one end of the post 400 is connected to the current collector 300, such that current can flow from the current collector 300 to the external terminal 100 through the post 400 and then flow to the busbar from the external terminal 100. In this way, the circuit of a battery will not be affected by the post 400 mounted on the inner surface of the external terminal 100.

Moreover, before a battery is assembled, the post 400 is fixed to the inner surface of the external terminal 100 to form a whole, and then the external terminal 100 and the post 400 are mounted on the lower shell 200 as a whole. In this way, the number of parts can be reduced during installation, and the assembly efficiency is improved.

Further, the post 400 is fixed to the inner surface of the external terminal 100 by welding, or the post 400 is integrally formed on the inner surface of the external terminal 100 by pressure casting.

Specifically, before assembly, the post 400 is welded to the inner surface of the external terminal 100 to form a whole, such that the post 400 and the external terminal 100 can be assembled as one part during assembly.

Further, the second through-hole 310 is a circular hole, and a cross-section of the first connecting segment 410 and a cross-section of the second connecting segment 420 are both circular.

Specifically, the cross-section of the post 400 is circular, and compared with other cross-sectional shapes, the post 400 with the circular cross-section has a larger cross-sectional area, thus having a better overcurrent capacity.

Further, a plurality of protrusions 430 are arranged on the step surface.

The plurality of protrusions 430 on the step surface are saw-toothed.

Specifically, circular saw-teeth are arranged on the step surface and can be inlaid in the current collector 300 during riveting to prevent the post 400 and the current collector 300 from rotating relatively, thus improving the connection strength of the post 400 and the current collector 300.

Further, two posts 400 are fixedly connected to the inner surface of the external terminal 100;
two first through-holes 210 are formed in the lower shell 200;
one current collector 300 is arranged on the inner side of the lower shell 200, two second through-holes 310 are formed in the current collector 300, and each of the two posts 400 penetrates through one first through-hole 210 to be fixed to the current collector 300.

Further, two posts 400 are fixedly connected to the inner surface of the external terminal 100;
two first through-holes 210 are formed in the lower shell 200;
two current collectors 300 are arranged on the inner side of the lower shell 200, one second through-hole 310 is formed in each current collector 300, and each of the two posts 400 penetrates through one first through-hole 210 to be fixed to the corresponding current collector 300.

Specifically, when two posts 400 need to be arranged, two independent current collectors 300 may be arranged on the inner side of the lower shell 200, and one second through-hole 310 is formed in each current collector 300 to rivet one post 400; or, one current collector 300 is arranged on the inner side of the lower shell 200, and two second through-holes 310 are formed in the current collector 300 to rivet the posts 400.

It should be noted that in a case where two independent current collectors 300 are arranged on the inner side of the lower shell 200, the two current collectors 300 can move separately until the second through-holes 310 in the two current collectors 300 are aligned with the two posts 400 respectively, and then the posts 400 and the current collectors 300 are connected.

In a case where one current collector 300 is arranged on the inner side of the lower shell 200 and two posts 400 are riveted to the same current collector 300, when the posts 400 are riveted, the two posts 400 on the current collector 300 should synchronously penetrate through the two second through-holes 310 in the current collector 300 to be riveted; in this case, although the requirement for the accuracy of the relative positions of the two second through-holes 310 in the current collector 300 is high, the integrity of the current collector 300 is better, and the current collector 300 and the lower shell 200 are better sealed.

Further, a first plastic part 500 is arranged between the external terminal 100 and the lower shell 200, and a second plastic part 600 is arranged between the lower shell 200 and the current collector 300.

Further, a sealing ring 700 is arranged at the first through-hole 210.

Specifically, the lower shell 200 can be sealed and insulated by means of the first plastic part 500, the second plastic part 600 and the sealing ring 700.

It should be noted that all directional indications (such as “upper”, “lower”, “left”, “right”, “front” and “back”) in the embodiments of the invention are merely used for explaining the relative positional relations or motions of components at a certain pose (as shown), and when the certain pose changes, the directional indications will change accordingly.

In addition, terms such as “first”, “second” and “one” involved in the invention are merely used for the purpose of description and should not be construed as indicating or implying relative importance or implicitly indicating the number of technical features referred to. Therefore, a feature defined by “first” or “second” may explicitly or implicitly indicate the inclusion of at least one said feature. In the description of the invention, “multiple” means at least two, such as two or there, unless otherwise expressly and specifically defined.

In the invention, unless otherwise expressly stated and defined, terms “connect” and “fix” should be broadly understood. For example, “connect” may refer to fixed connection, detachable connection or integrated connection; or, mechanical connection or electrical connection; or, direct connection, indirect connection by means of an intermediate medium, or internal connection or interaction of two elements. Those ordinarily skilled in the art can appreciate the specific meanings of these terms in the invention as the case may be.

In addition, the technical solutions in the embodiments of the invention can be combined as long as they can be implemented by those ordinarily skilled in the art. When a combination of the technical solution causes a contradiction or cannot be implemented, the combination of the technical solutions should be considered as non-existent and should not fall within the protection scope of the invention.

What is claimed is:

1. A riveting structure for cell posts, wherein a cell comprising a lower shell, an external terminal and a current collector, the external terminal being arranged on an outer side of the lower shell, the current collector being arranged on an inner side of the lower shell, the external terminal having an inner surface facing the lower shell and an outer surface backing on to the lower shell, the outer surface of the external terminal being connected to a busbar, wherein a first through-hole is formed in the lower shell, and a post has an end fixedly connected to the inner surface of the external terminal as well as an end penetrating through the first through-hole and riveted to the current collector;
the post comprises a first connecting segment and a second connecting segment, and a first step surface is formed at a joint between the first connecting segment and the second connecting segment; from the second connecting segment to the first connecting segment, a cross-sectional area of the second connecting segment becomes smaller gradually;
a second through-hole is formed in the current collector, and a cross-sectional area of the second through-hole is greater than a maximum cross-sectional area of the second connecting segment and less than a cross-sectional area of the first connecting segment.

2. The riveting structure for cell posts according to claim 1, wherein the post is fixed to the inner surface of the external terminal by welding or is integrally formed on the inner surface of the external terminal by pressure casting.

3. The riveting structure for cell posts according to claim 1, wherein the second through-hole is a circular hole, and a cross-section of the first connecting segment and a cross-section of the second connecting segment are both circular.

4. The riveting structure for cell posts according to claim 1, wherein a plurality of protrusions are arranged on the step surface.

5. The riveting structure for cell posts according to claim 4, wherein the plurality of protrusions on the step surface are saw-toothed.

6. The riveting structure for cell posts according to claim 1, wherein two said posts are fixedly connected to the inner surface of the external terminal;
two said first through-holes are formed in the lower shell;
one said current collector is arranged on the inner side of the lower shell, two said second through-holes are formed in the current collector, and each of the two posts penetrates through one said first through-hole to be fixed to the current collector.

7. The riveting structure for cell posts according to claim 1, wherein two said posts are fixedly connected to the inner surface of the external terminal;
two said first through-holes are formed in the lower shell;
two said current collectors are arranged on the inner side of the lower shell, one said second through-hole is formed in each said current collector, and each of the two posts penetrates through one said first through-hole to be fixed to the current collector.

8. The riveting structure for cell posts according to claim 1, wherein a first plastic part is arranged between the external terminal and the lower shell, and a second plastic part is arranged between the lower shell and the current collector.

9. The riveting structure for cell posts according to claim 1, wherein a sealing ring is arranged at the first through-hole.
